(19) United States
(12) Patent Application Publication
(10) Pub. No.: US 2013/0159117 A1
(43) Pub. Date: Jun. 20, 2013

(54) APPARATUS, SYSTEM AND METHOD OF PROVIDING DEDICATED MOBILE APPS FOR USE BY CELEBRITIES

(71) Applicants: Joseph Sanginiti, Yardley, PA (US); John Fries, Moorestown, NJ (US)

(72) Inventors: Joseph Sanginiti, Yardley, PA (US); John Fries, Moorestown, NJ (US)

(21) Appl. No.: 13/611,870

(22) Filed: Sep. 12, 2012

Related U.S. Application Data
(60) Provisional application No. 61/533,504, filed on Sep. 12, 2011.

(51) Int. Cl. H04L 29/08

(52) U.S. Cl. CPC H04L 67/02
USPC 705/14.73

(57) ABSTRACT

A system for providing a software application customized with subject matter pertaining to a celebrity, including a processor, data storage, and software thereon that implement a content provision hub operable to provide a mobile application and content related thereto for download to a user device, an advertising server operable to download an advertisement under the direction of the content provision hub to the mobile application, and a charging engine operable to effect a payment transaction between the celebrity, the user, and/or an advertiser. The system can be used by a celebrity generate a celebrity-specific downloadable mobile application by selecting templates and options that control the celebrity app appearance and operation.

### CROSS-REFERENCE TO RELATED APPLICATIONS

This application claims benefit under 35 U.S.C. §119(e) of U.S. Provisional Patent App. Ser. No. 61/533,504, filed Sep. 12, 2011, which is incorporated herein by reference in its entirety.

### BACKGROUND

1. Field of the Invention

The present invention relates to mobile applications, and, more particularly, to an apparatus, system and method of providing dedicated mobile apps for use by celebrities.

2. Background of the Invention

The mobile app marketplace is growing by leaps and bounds. The estimated total number of smartphones sold will exceed 450 million in 2011, an increase of approximately 49.2% over 2010. By 2015, the number is estimated to grow to 630 million.

It is estimated that 60% of the time spent on smartphones is spent on mobile apps. With regard to sports alone, it is estimated that 88% of the people in the U.S. follow at least one sport which equates to over 200 million prospective mobile sports app users. This fuels $5.2 billion to be spent on advertising in the mobile app industry. Future markets for apps include television as users increase use of smart TVs and internet protocol (“IP”) TVs. In 2010, 21% of the TVs sold had an internet connection. That is expected to grow to 50% by 2014.

However, there is very limited participation in the space for dedicated mobile apps for celebrities. Such dedicated apps could enhance celebrity profiles, deepen fan bases, and create new avenues of revenue. The only mobile app activity presently related to this field is apps focused on a company, league, or team. However, even with respect to such apps, these apps are typically shared among teams, leagues, or companies.

Thus, the need exists for an apparatus, system and method of providing a dedicated mobile app for celebrities.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrate aspects of exemplary embodiments of the present invention;

FIG. 5 illustrates an aspect of an exemplary embodiment of the present invention; and

FIG. 6 illustrates an aspect of an exemplary embodiment of the present invention.

### DETAILED DESCRIPTION

Computer-implemented platforms, engines, systems and methods of use are disclosed that provide networked access to a plurality of types of digital content, including, but not limited to video, audio, metadata, interactive and document content, and that may track, deliver, manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

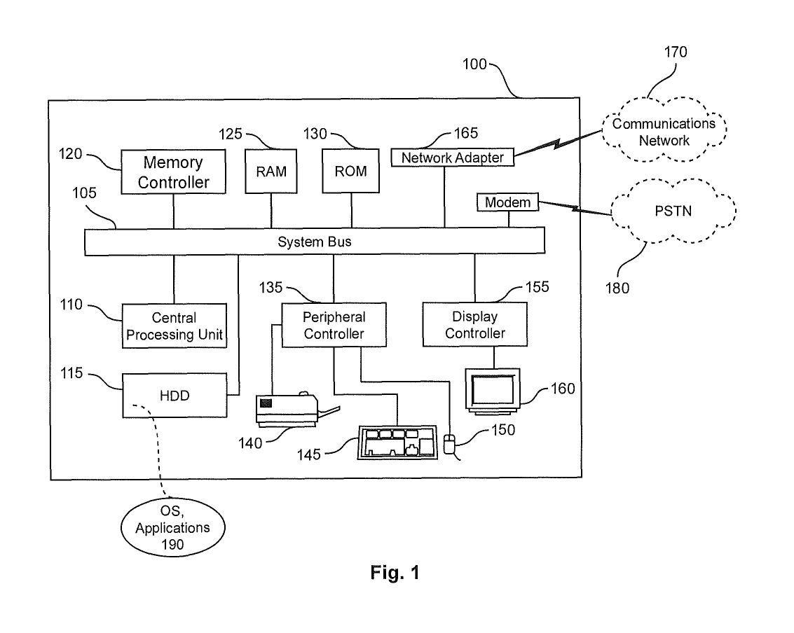

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

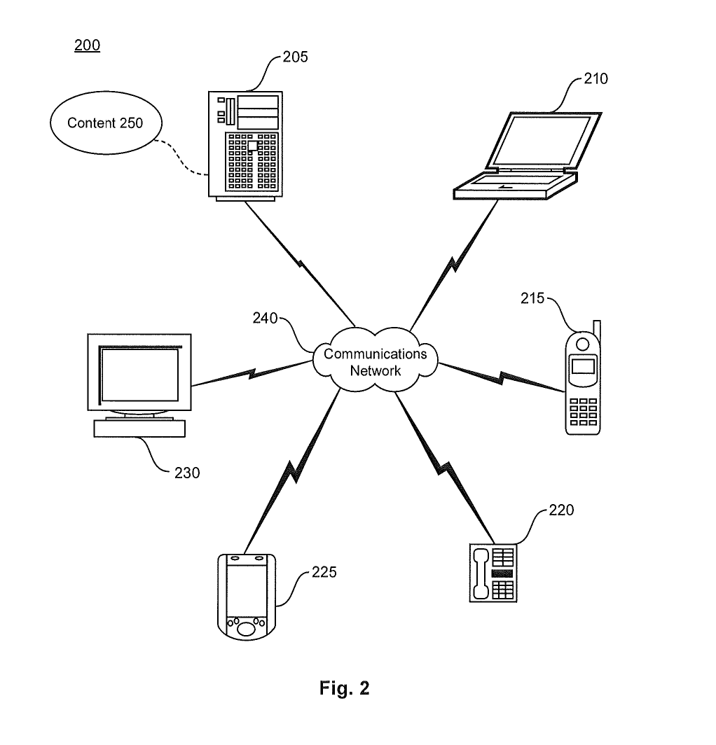

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 may comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 may utilize various data security protocols such as secured socket layer (SSL), pretty good privacy (PGP), virtual private network (VPN) security, or the like. Each client device 210, 215, 220, 225, 230, etc., may be equipped with an operating system operable to support one or more computing and/or communication applications, such as a web browser (not shown), email (not shown), or the like, to interact with server 205.

The present invention provides strategic mobile entertainment, and more particularly includes a mobile application (“app”), content delivery system and method, and a social networking environment for celebrities. The present invention powers every athlete, celebrity, agent, entertainer, content producer, company, league or like well known entity (collectively “celebrity”) with an application platform and content service delivery network enabling the celebrity to create, deploy, and manage his/her “app” in real time. In addition, this gives the celebrity the ability to enhance his/her profile, deepen his/her fanbase, and create an avenue to monetize his/her celebrity.

The present invention provides a user friendly mobile app interface that provides the opportunity for top sports and entertainment personalities (in coordination with their agent, business manager, etc.) to connect with followers. Along with followers, the present invention provides a collective advertising base that assists celebrities in achieving greater revenue results, allows celebrities to have an increased impact on society, and allows celebrities to achieve a meaningful and long lasting legacy.

The technology may provide a content aggregation and management tool. The technology further provides media information, social networking, merchandising, statistics, philanthropy, and a push notification that encourages continued contact between the celebrity and his/her followers. The technology may also allow for a variety of revenue models.

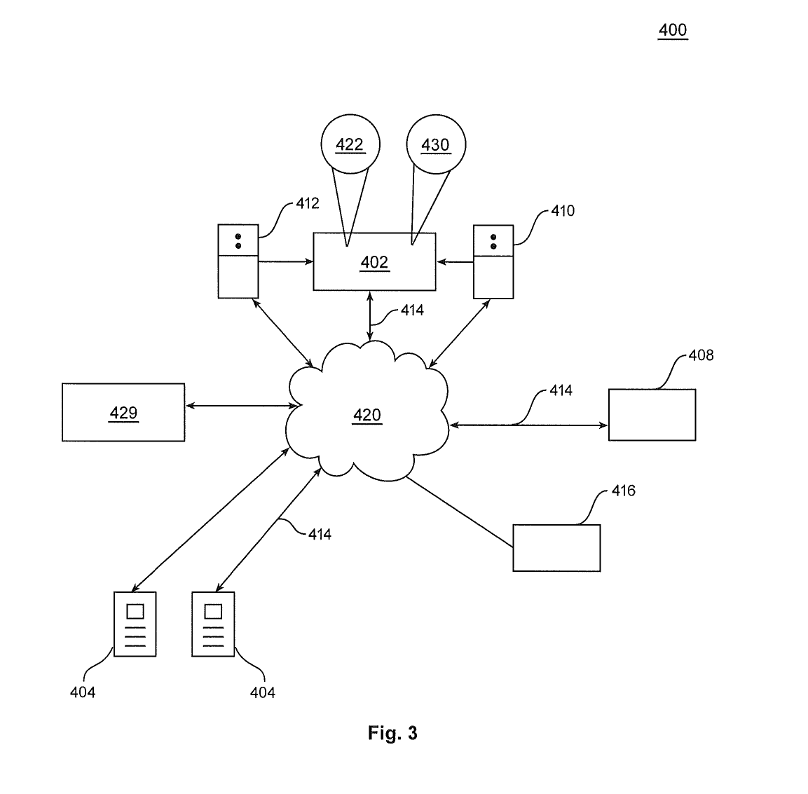

FIG. 3 illustrates a system 400 of providing at least a mobile app in accordance with the present invention. As shown, the system 400 may include at least a content provision hub 402, which provides a mobile app download and content related thereto for a plurality of mobile apps downloaded to a plurality of user devices. Each such download provides a user app graphical user interface 404 to provide the app content to the users. The content hub further provides a graphical user interface 408, such as a mobile interface, to at least one celebrity, to enable the celebrity to select and/or upload content for download to the user device apps 404. The hub 402 preferably additionally tracks all app downloads and user activities, activities of charging server 412 and advertising server 410, and the like, across different celebrities' apps.

The system 400 further includes an advertising server 410 that downloads advertisements at the direction of hub 402 to mobile apps 404. Also included is the charging server 412, which tracks the charges, i.e., payments due to or from advertisers, the celebrity, or the user. Content 414 may be accessed/generated by celebrity upload, from third party service 416, and/or from the cloud 420. Certain of content 414 may require normalization by unifeed normalizer 422 within hub 402 for use of app 404 across multiple platforms and devices. Hub 402 may further include auto-editor 430, which may edit content using a plurality of editing rules to remove objectionable content in accordance with entered user ages for app users, parental controls, FCC regulations, rules of conduct, or the like.

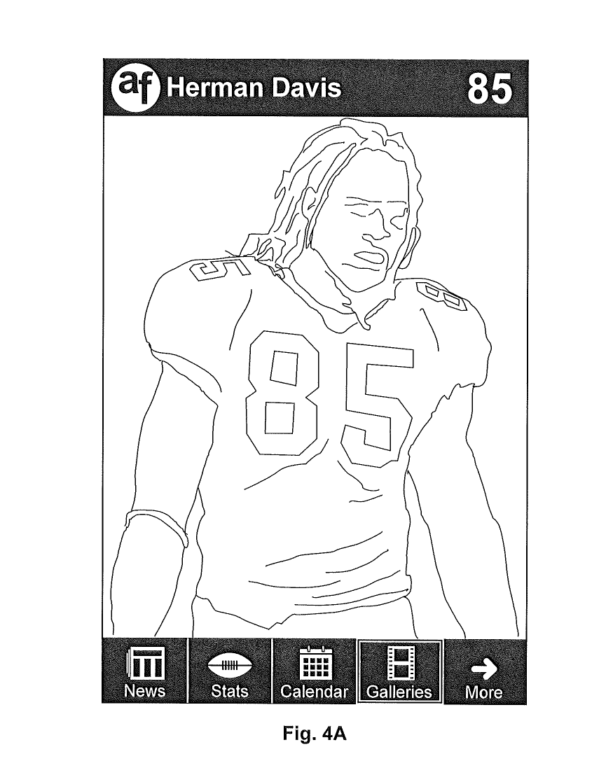

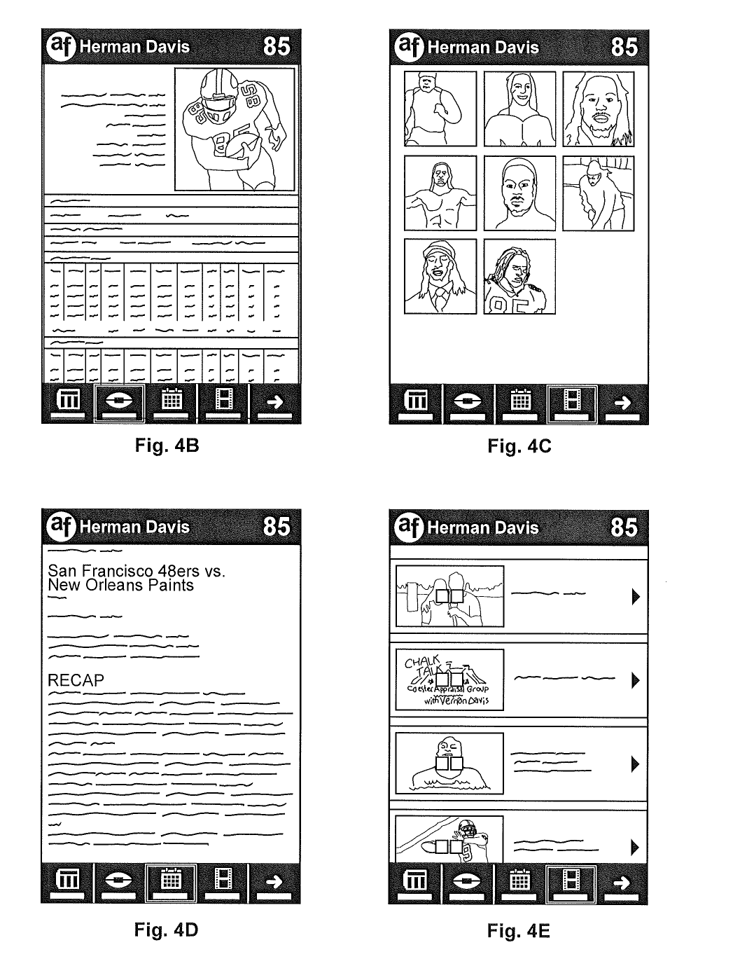

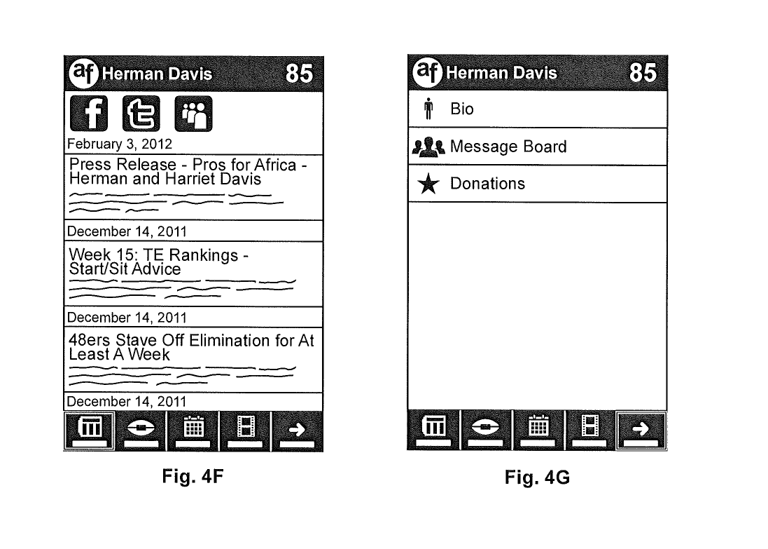

The present invention thus provides a “dedicated app” for celebrities. That is, a celebrity or similar well known person may invite fans to download his/her app in order to “follow” solely him/her. At present, celebrities must “share” apps and sites with other celebrities who provide information using that same app or site. “Following” the celebrity through the app of the present invention may thus include, by way of example, providing of statistics of that celebrity (such as for a sport played, television shows starred in, etc.), the availability to request endorsements from that celebrity, the capability to donate money to the favorite charity of that celebrity, the availability to purchase products or services endorsed by that celebrity, the aggregation of social networking feeds of that celebrity (Le. Twitter or Facebook), and the like, as illustrated in FIGS. 4A, 4B and 4C. More particularly, the aggregating engine 429 of the present invention may allow for the celebrity to choose content related to him/her from anywhere, and may allow the celebrity to decide what content users will have access to in relation to that celebrity within the celebrity's dedicated app.

More particularly, in part because the present invention includes a “dedicated app” for that celebrity, the celebrity may control what appears in his/her app, and/or may be provided with selectable templatization to elect what appears in his/her app. The celebrity may elect what is said in his/her app, such as subject to the editing rules discussed herein with respect to FIG. 3. For example, the celebrity may elect to push to users alerts or information, via the app, such as to support/endorse a cause, and the app thus allows the celebrity to receive donations or direct donations to support a favored cause, within the app or otherwise.

Likewise, the celebrity may select what, or how, to charge for his/her app, and where monies received for the app go. By way of non-limiting example, the celebrity may allow that his/her app be downloadable by fans for a predetermined amount, such as $0.99, and may indicate that a certain percentage, such as 90%, of the proceeds gained from the downloading of the app will be paid to the celebrity's endorsed charitable cause (wherein all or a portion of the remainder may be payable to the operators of the present invention and/or to the celebrity). On the other hand, by way of example, if the celebrity wishes fans who download his/her app to donate from within the app to the celebrity's recommended cause “du jour,” and particularly if this cause may change from time to time, the celebrity may prefer to maximize downloads (and hence to maximize potential donors) by offering the app for free.

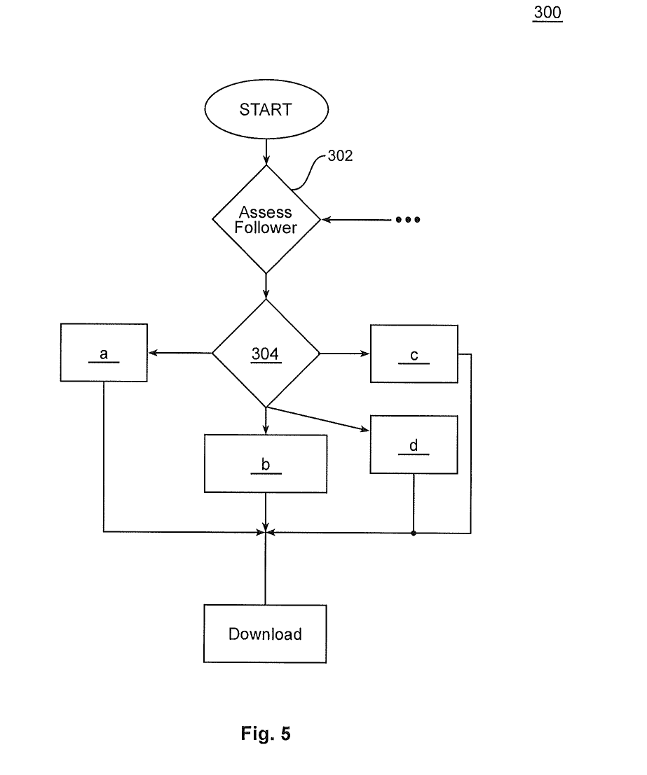

FIG. 5 illustrates a method of assessing a charge, such as by the charging server discussed in FIG. 3, for an app in the present invention. As illustrated, the exemplary method 300 may allow for maximization of profitability or income from the downloading, or for the maximization of users (such as to optimize advertising income). As shown, the present invention may, upon receiving a request for a dedicated app for a celebrity, company, entity and/or cause (collectively “celebrity” in this example), assess that celebrity's followers for current social media, at step 302. Thereafter, at step 304, business rules may be applied that indicate amounts to be charged for the dedicated app, or for downloaders of the dedicated app. For example, at step 304a , any celebrity with at least 25,000 followers, or friends, on one of Facebook, Twitter, MySpace, LivingSocial, or the like, may be provided with the requested app for free, and users may be able to download the app for free, thereby optimizing the large number of available users for advertisements in or in relation to that celebrity's app. At step 304b , any celebrity with at least 100,000 followers or friends on another social media site may be offered a stipend, such as from a proposed sponsor of the app for that celeb. Thereby, the present invention provides sponsorship opportunities of a particular celebrity's app that may be opened for bid.

At step 304c , any celebrity with at least 10,000 followers may receive the app for free, but users may be charged a particular amount, such as, for example, $0.99, to download the app. Alternatively, a user at any step of the present invention who is asked to pay for the app may be offered alternative advertising-based options. For example, the user may agree to use a version of the app that provides advertising in order to eliminate, in whole or in part, an initial charge for the app. Additionally and alternatively, different levels of charges may be levied upon the user based on how many ads the user is willing to accept (i.e., the app may be $9.99 if to be received with no ads, $4.99 with one banner ad per screen view, $0.99 with two ads per screen, or free with unlimited ads per screen). Additionally and alternatively, the user may receive the paid app for free, such as with the purchase of a product or service endorsed by the subject celebrity. Needless to say, in such a case it is preferable that the provider of the product or service so-endorsed must pay a charge to the charging engine of the present invention.

Yet further, at step 304d , any celebrity with less than 10,000 followers may be charged to obtain a dedicated app, and additionally, users may optionally be charged to download the app. Of course, those skilled in the art will appreciate that any one, or other, options for payments or charging for the app, or download thereof, discussed herein may be used with the present invention. By way of non-limiting example, a celebrity may enter his/her “likes” into his/her app, either directly or by importation from a third party social media site, and exploration by a user of such likes may affect a “per-click” charge to the advertiser of the “liked” product or service. Further, exploration and/or purchase of a “liked” or recommended product or service may affect a charge to the advertiser payable to the charging engine, and/or to the athlete, such as through the tracking/charging engine. As such, the present invention may provide metrics as to the success of the endorser as an endorser across all instances of that endorser's app, such as may be tracked by the content provision hub.

As discussed herein, obtaining a dedicated app may thus make available to the celebrity endorsements, or sponsorships, not otherwise available to the celebrity. Such endorsements or sponsors may be provided by interface of the present invention to one or more third party purveyors of endorsement or sponsorship opportunities for celebrities. Further, providing the interface to such third party information, such as databases, may allow for collection, by the charging engine of the present invention, of monies to the charging engine as a percentage of any endorsement or sponsorship gained by the celebrity for association with his/her dedicated app.

Further, the charging engine may allow for a charge to an advertiser for placing an advertisement in the celebrity's dedicated app. This charge may particularly be levied in the case that the celebrity has an existing endorsement deal with an advertiser, and that advertiser now wishes to place advertisements into the dedicated app of the endorser. Thereby, the charging engine may monitor amounts payable, such as to/from the celebrity, to/from an advertiser, and/or to the operator of the charging engine. For example, the charging engine may track that a celebrity is to pay a fee to make available his/her app, that an endorser is to pay a percentage of ad revenue from the app, that a portion of download fees paid by users is payable to the operator, and/or that a percentage of merchandise sales made through the app, such as sales of products endorsed by the subject celebrity, is to be paid to the operator.

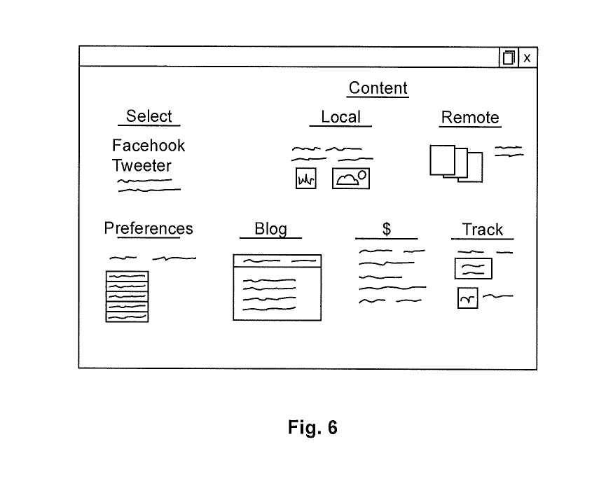

FIG. 6 illustrates a template that may be provided to a celebrity in preparing a dedicated app for use in the present invention. Thereby, the celebrity can prepare a dedicated app from anywhere, and can interact with his/her dedicated app from anywhere. As such, the celebrity may set preferences for interacting with the celebrity's GUI for his/her app, and/or may set preferences for how users interact with that celebrity's app. Such preferences may be enforced across devices and/or across platforms. Further, service of content through the content provision hub/server of the present invention may allow for enforcement of the aforementioned content editing/monitoring rules before content is served to users.

For example, the content provision server may include the afore-discussed unifeed normalizer for multi-platform and multi-device interaction. Such a normalizer may be based on JavaScript Serialized Object Notation (JSON), which may allow information received from, sent from, or queried by the normalizer/third party sources to be normalized from a native language via JSON to provide downstream compatibility between the normalizer/third party sources and multiple client devices accessing the normalizer.

As mentioned hereinthroughout, the present invention may be based in a content provision hub from which all apps are provided. The hub can thus track apps downloaded, amounts paid and reasons for payment, the popularity of certain celebrities having apps (i.e., how many apps have been downloaded, and/or are downloaded daily, weekly, monthly, or the like), the success rate of the celebrity as an endorser, the demographic/profile data of users who follow a particular celebrity or celebrities, the likes of celebrities and/or users in a certain field, the purchasing data of purchases made by users through the app, and the like. Thereby, a large volume of inter-related demographic, purchasing and popularity data may be accumulated by the hub. This data may be used for typical means, such as targeted marketing or the like, and additionally may be used to indicate the celebrity's value as a brand—that is, to allow a celebrity to become an informed brand, whereby the celebrity is aware of, and can illustrate, his/her value as an endorser, as a recipient of sponsorships, as a supporter of causes, and as a public relations net value, by way of non-limiting example.

The celebrity may, as mentioned herein, provide any of a variety of new, aggregated, or advertising content through the celebrity's dedicated app. For example, the celebrity may offer his/her own “show,” such as to provide “personal press conferences” to that celebrity's fans, or to provide that celebrity's in-app reality show to fans, by way of non-limiting example. Of course, to the extent such a show is provided via video, either in discrete portions, or in a lengthy or non-stop “reality show” format, other revenue opportunities are made available to the athlete by the present invention—such as, but not limited to, endorsements, product placements, and the like.

Additionally, a celebrity may offer “virtual tours,” such as in relation to a “show.” Such tours may be available for locations endorsed by that celebrity, and/or for a stadium (to which tickets are also made available, such as via link within the subject app) in which an athlete plays, and/or of a celebrity's house in an exotic locale. Likewise, a celebrity may offer “virtual access” to other aspects of his/her life from within his/her app. For example, to the extent the celebrity plays fantasy sports, the celebrity's fantasy sports teams may be shown in his/her app. Yet further, either for free or a fee, a user may be enabled to play fantasy sports using the celebrity's fantasy team(s), or against the celebrity's fantasy team(s). Likewise, the user may pay to play in a league against the favorite celebrity and/or his/her team.

In such scenarios, to the extent a user pays a fee to play, cash prizes to users may be offered, such as from the pooling of monies of participants and/or from a sponsor of the league associated with that particular celebrity. To the extent the celebrity wins, or places “in the money,” the celebrity's winnings may be donated to a favorite cause of the celebrity according to the celebrity's app. For example, if the celebrity wins, all winnings may be donated to the Cystic Fibrosis Foundation, listed elsewhere in the celebrity's app as a favored charity of the celebrity.

For example, a user may be enabled to play fantasy sports through an app provided by a celebrity or by an official league. Such leagues may occur in the typical manner over the course of a season, and/or may be played daily, such as with new teams each day. Daily leagues may be played, as mentioned above, for cash prizes, and may be directed to baseball, soccer, or golf, for example. Weekly games might be directed to college or pro football, for example. In any such case, inclusion of the athlete that is the subject of the app on a fantasy team may allow a link from that celebrity providing real-time game day thoughts, injury updates, expectations, or the like, for that athlete or teammates. As such, a user may download apps of one or more players on a fantasy team, such as to get alerts or the like regarding that player or those players. Likewise, a user may execute fantasy sports transactions, such as with respect to the subject athlete of the app, such as by linking the user's fantasy sports team to the app of the present invention (Le., by entry of the link to a league, along with a user name and password).

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented system for providing a software application customized with subject matter pertaining to a celebrity as a celebrity application, comprising:
a computing processor;
a non-transitory computer readable data content storage device in data communication with the processor and having stored thereon content pertaining to the celebrity;
a tangible communication connection device in data communication with the processor and operative to communicatively couple the processor to a tangible data communication network; and
a non-transitory computer-readable software storage device in data communication with the processor having stored thereon computer readable instructions which, when executed on the processor, cause the computer to implement:
a content provision hub operable to provide a mobile application and content related thereto for download to a user device;
an advertising server operable to download an advertisement under the direction of the content provision hub to the mobile application; and
a charging engine operable to effect a payment transaction between the celebrity, the user, and/or an advertiser.

2. The system of claim 1, wherein the celebrity is one of an athlete, an agent, an entertainer, a content producer, a company, a league or a well-known entity.

3. The system of claim 1, wherein the computer instructions cause the computer to further implement a unifeed normalizer operable to present at least a portion of the stored content across a plurality of different devices.

4. The system of claim 1, wherein the computer instructions cause the computer to further implement an auto-editor operable to edit content in accordance with a rule.

5. The system of claim 4, wherein the rule causes the auto-editor to remove objectionable content in accordance with at least one of an entered ages for an app user, a parental control, an FCC regulation, and a predetermined rule of conduct.

6. The system of claim 1, wherein the mobile application, after being downloaded to and installed on a user device and while executing thereon, interacts with a network presence of the celebrity.

7. The system of claim 6, wherein the network presence resides on a social network.

8. The system of claim 7, wherein the social network is one of Facebook, Twitter, MySpace, and LivingSocial.

9. The system of claim 6, wherein the charging engine charges an advertiser for placing an advertisement in the mobile application as it executed on a user device.

10. The system of claim 6, wherein the mobile application provides a user interface to the user operable to provide at least one user capability from the group comprising: viewing statistics pertaining to the celebrity; requesting an endorsement from the celebrity; donating money to the favorite charity of the celebrity; purchasing a product or service endorsed by the celebrity; and the aggregation of a plurality of social networking feeds of the celebrity.

11. The system of claim 6, wherein the computer instructions cause the computer to further implement an aggregating engine operable to:
collect content related to the celebrity from a plurality of online sources; and
enable the celebrity to select a portion of the content for sharing with the user via the mobile application executing on the user device.

12. The system of claim 6, wherein the computer instructions cause the computer to enable the celebrity to push information to the user device.

13. The system of claim 1, wherein the computer instructions cause the computer to provide an interface for use by a third party to offer an endorsement or sponsorship opportunity to the celebrity.

14. The system of claim 1, wherein the charging engine payment transaction is a charge to an advertiser for placing an advertisement in the celebrity application.

15. The system of claim 1, wherein the software storage device stores a template and the computer instructions cause the computer to provide the template to the celebrity for use in preparing the celebrity app, including setting preferences that control the appearance of the celebrity application user interface and how the user can interact with the celebrity application.

16. The system of claim 1, wherein the content provision hub is further operable to track and aggregate information of a plurality of downloads of the celebrity application, including at least one of: payment transactions made through the celebrity application; reasons for the payment transactions; how many instances of the celebrity application have been downloaded on a daily, weekly, monthly, or other periodic basis, and/or the popularity of the celebrity based thereon; the success of the celebrity as an endorser; data of users who follow the celebrity; the likes of the celebrity and/or the users in a certain field.

17. The system of claim 17, wherein the celebrity application is one of a plurality of celebrity applications, each pertaining to a different celebrity; and wherein the content provision hub is further operable to track, aggregate, and compare information of the different celebrities generated via the celebrity applications,
